(19) United States
(12) Patent Application Publication
(10) Pub. No.: US 2010/0186237 A1
(43) Pub. Date: Jul. 29, 2010

(54) Fluidic utensils

(76) Inventor: Kenneth Thomas Cunningham, Hazlet, NJ (US)

Correspondence Address: William M. Fischer, 3 Lillian Dr., Hazlet, NJ, 07730, US

(21) Appl. No.: 12/321,943

(22) Filed: Jan. 27, 2009

(51) Int. Cl. B25F 1/00

(52) U.S. Cl. 30/123.3

(57) ABSTRACT

Described herein are eating utensils forks, spoons and chopsticks which have imparted upon them the function of liquid dispensing and aspirating via fluidic passages inside of the utensils which attach to a container of a liquid affixed at a point either within or at the top end of the handle of the utensil. The attachment coupled with the action of the user of the utensil actuates the flow of the liquid from the container to the eating surface of the utensil.

### BACKGROUND OF THE INVENTION

This invention pertains to the field of eating utensils, mainly forks, spoons and chopsticks. This invention also pertains to the field of food condiment dispensing devices, as well as devices for dispensing orally-dosed liquid medicine, vitamin and liquid supplements.

### BRIEF SUMMARY OF THE INVENTION

The object of this invention is to impart the function of liquid dispensing and aspirating to the eating utensils forks, spoons and chopsticks. Inside the utensils are fluidic passages connecting to a container of a liquid affixed at a point either within or at the top end of the handle of the utensil. The fluid in the container attached to the utensil is allowed to flow through the passages in order to be dispensed at a point at the bottom end of the utensil, the bottom end being the working end. In the case of a fork, the working end contains an ordinarily shaped fork having at least two prongs. In the case of a spoon, the working end contains an ordinarily shaped spoon bowl. In the case of a chopstick, the working end contains an ordinarily shaped chopstick tip. Fluid dispensing is actuated by gravity after the container is affixed or by manual pressure, as in squeezing the container or depressing a syringe-type plunger into the container. These fluidic utensils are useful in applications for the dispensing and aspiration of liquid formulations of medicines, nutritional supplements and food condiments. Dispensing and aspirating fluids in this way is advantageous since the user may control the volume of fluid dispensed and the location the fluid is dispensed to. The user of these fluidic utensils may also control what is aspirated into the utensil, as in switching from various condiments or dressings over the course of a meal.

### BRIEF DESCRIPTION OF THE SEVERAL VIEWS OF THE DRAWINGS

FIG. 1 depicts perspective views of the working ends of four embodiments of the claimed invention. In FIGS. 1A, 1B and 1C, the section lines denote the internal fluid passages found within the utensil through which fluid is dispensed from or aspirated into a container piece containing a liquid. FIG. 1A is a spoon embodiment of the claimed invention. In FIG. 1A, the internal fluid passage shown by section lines extends from the handle body and exits at the working end at any point in the downward sloping region of the juncture of the spoon bowl working end with the handle body. FIGS. 1B and 1C show two fork embodiments of the claimed invention. In FIG. 1B, section lines depicting the internal fluid passages extend to at least one of the tips of the fork, the fork having at least two prongs. The fluid passages exit at the tips of the fork prongs after branching off a single passage extending through the body of the utensil handle. The point of the branching is a junction located inside the utensil at any point between the inner edges of the fork prongs adjacent to the utensil handle body and the juncture of the working end with the handle body. In FIG. 1C, the fluid passage shown by section lines extends through and exits the utensil at any point between the inner edges of the fork prongs adjacent to the utensil handle body and the juncture of the working end with the handle body. FIG. 1D is a chopstick embodiment of the claimed invention. The working end of the chopstick embodiment contains an exit hole at its tip and a single fluid passage extending to the tip through the handle body.

FIG. 2 depicts perspective views of the top end and handle body portions of two embodiments of the claimed invention. In FIG. 2A, the section lines starting at the top of the handle body and extending down to the sectionally drawn cylinder are the cage legs of the handle body which are hidden from view. The remainder of the section lines in FIG. 2A, including the aforementioned cylinder, depict the internal fluid passage that extends to the working end of the utensil. The handle body of the utensil shown in FIG. 2A is a hollow cavity defined by at least three handle cage legs. This cavity may or not contain a fixed or removable cover at its top end. A fluid container is placed into the hollow cavity of the utensil handle body and the container's dispensing end is inserted into the fluid passage. The section lines of FIG. 2B represent the internal fluid passage of another embodiment of the handle body of claimed invention. The portion of the handle body in FIG. 2B above the sectionally-drawn cylinder is a hollow cavity with solid or flexible walls. Into this cavity is inserted from the top a fluid container with a dispensing end being inserted into the fluid passage.

FIG. 3 depicts perspective views of the top ends of two embodiments of the claimed invention. In all the views in FIG. 3, sectional lines represent the internal fluid passages. The fluid containers shown are a squeezable bag and syringe assembly. These fluid-dispensing or fluid-dispensing and fluid-aspirating containers can be attached to the top of the utensil handle body by a snap- or screw-fit as in a Luer-Lock fitting as shown in FIGS. 3A and 3c. An alternative fitting of the fluid container to the top of the handle body is a threaded screw as shown in FIGS. 3B and 3d. When attached to the top of the utensil handle body, fluid may be dispensed or aspirated to and from the holes found at the working end of the utensil, as shown in FIG. 1. The attachments depicted in FIG. 3 of the fluid container to the utensil handle body are also applicable to the handle body embodiments depicted in FIG. 2.

### DETAILED DESCRIPTION OF THE INVENTION

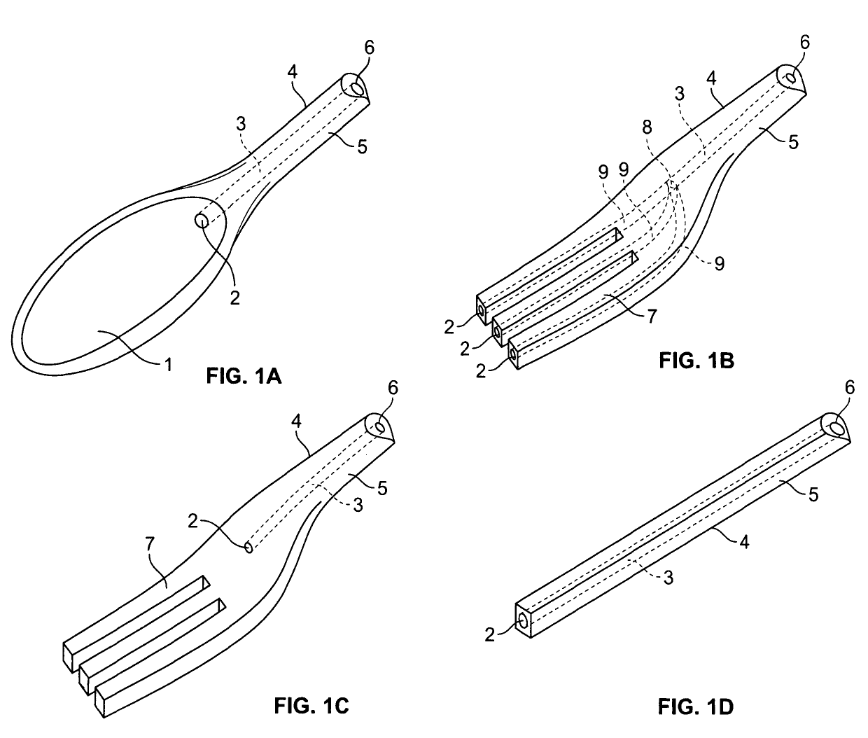

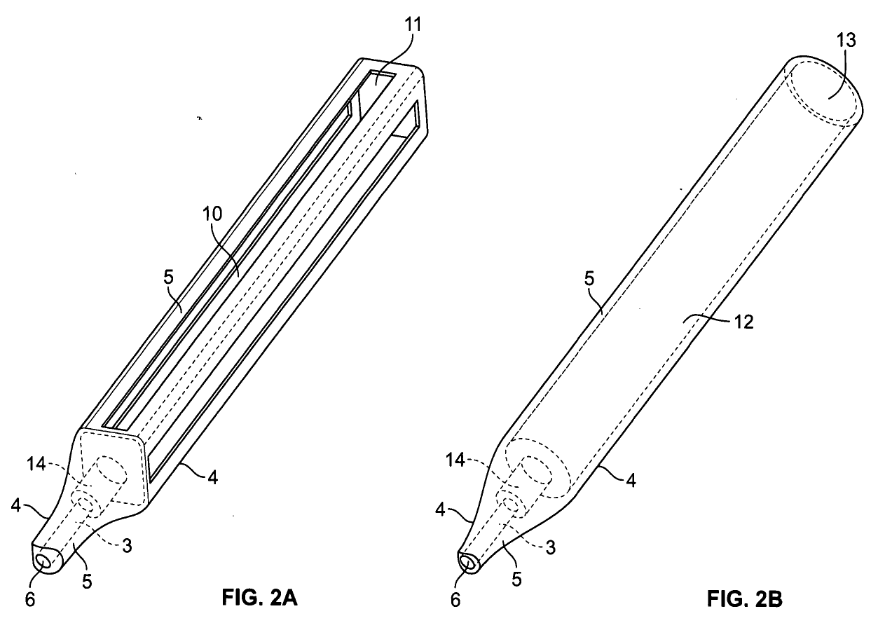

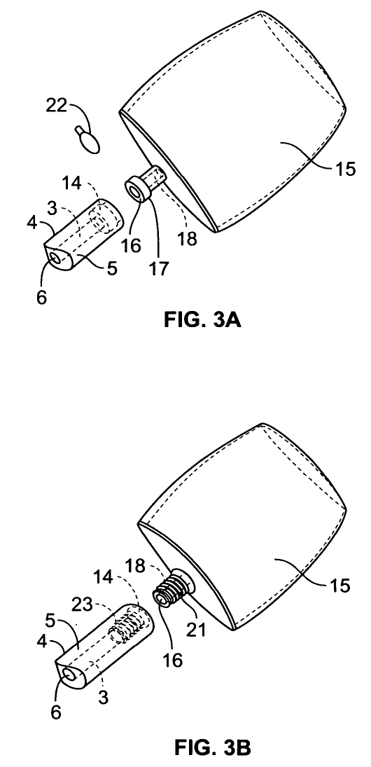

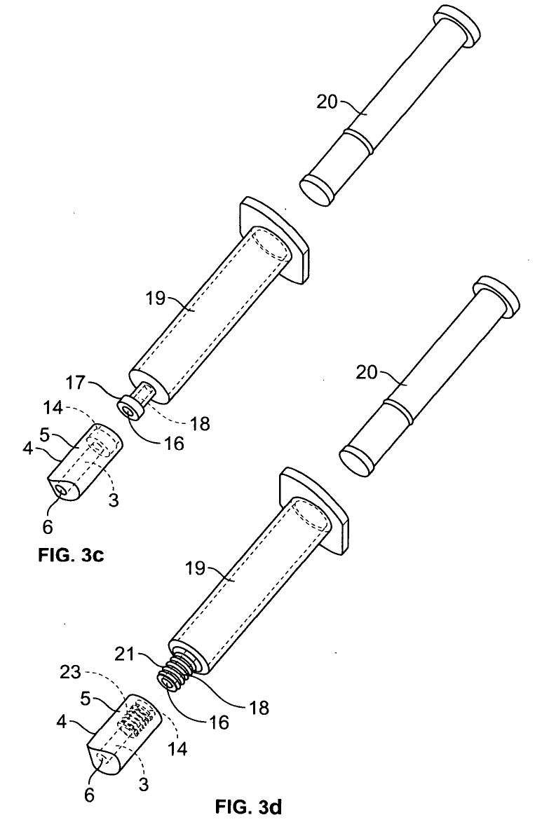

FIG. 1 of the drawings depicts the working ends of four embodiments of the claimed invention. In the spoon embodiment, FIG. 1A, an exit hole 2 of the internal fluid passage 3 enters into the spoon bowl 1. The fluid passage 3 passes through the utensil handle body and extends upwards through the handle body toward a fluid container as depicted in FIGS. 2 and 3. This internal fluid passage is separated from the surface 4 of the utensil handle body by the material of construction 5 of the utensil. The fluid passage interior surface 6 may be cut or bored through the utensil handle body or may be a fitted tube including a replaceable or disposable tube. The fluid passage 3 depicted in FIG. 1A exits at one exit hole 2 located at any point in the downward sloping region of the juncture of the spoon bowl working end with the handle body.

In one of the two disclosed fork embodiments shown in FIG. 1B, the internal fluid passage 3 branches into at least two branching internal fluid passages 9 at an internal junction 8. The branching internal fluid passages 9 extend through at least two fork prongs 7 and exits the tips of least two of the prongs at exit holes 2. In the case of a fork embodiment having an exit hole 2 at the tip of only one of the fork prongs 7, the branching internal fluid passages and internal junction 8 are unnecessary and can be replaced by a single internal fluid passage 3 that extends to an exit hole 2 at the tip of the fork prong 7.

A second fork embodiment of the claimed invention, depicted in FIG. 1C, does not make use of branching internal fluid passages 9 but rather employs the single exit hole 2 as in the spoon embodiment of FIG. 1A. The fluid passage 3 depicted in FIG. 1C exits the utensil at one exit hole 2 located at any point between the inner edges of the fork prongs 7 and the juncture of the working end with the handle body, which may or may not be downwardly sloping.

In the chopstick embodiment of FIG. 1D, a single fluid passage 3 extends through the utensil handle body, exiting at the eating-end through a single exit hole 2.

Referring to FIG. 2, two embodiments of the utensil handle body of the claimed invention are shown. FIG. 2A is a hollow cage structure 10 having at least three cage legs whose material of construction 5 and surface 4 may be of the same type and be continuous with the working end of the utensil. A top enclosing structure 11 may or may not be present. The surface of the cage legs 4 and the surface of the remainder of the handle body 4 may or may not be continuous and the hollow enclosure structure 10 may be detachable or disposable. Into the hollow enclosure structure 10 may be placed a fluid container with a nozzle-like structure to be fitted into a receiver 14 which connects to the internal fluid passage 3 extending to the working end of the utensil. Fluid are dispensed from the container affixed into the hollow enclosure structure 10 and the receiver 14 by squeezing or by gravity, or a combination of these forces exerted by the user of the utensil.

The utensil handle embodiment shown in FIG. 2B makes use of a closed fluid containing space 12 with an open top orifice 13. A fluid container is placed into the space 12 with its dispensing end fixed into a receiver 14. The embodiment of FIG. 2B is also suited to the use of a syringe to be used for dispensing or aspirating fluids into the closed fluid containing space 12. In that case, a syringe plunger may be employed alone by insertion into the space 12 through the top orifice 13 without having any container affixed to the receiver 14. Alternatively, an entire syringe assembly may be inserted into the closed space 12 with the plunger extending out of the top orifice 13 and the bottom dispensing end of the syringe affixed permanently or removeably into the receiver 14.

Fluid containers may be affixed within the utensil handle body as in FIG. 2 or to the top end of the handle body as shown in FIG. 3. In FIGS. 3A and 3B, the fluid container 15 is a squeezable or otherwise actuated to dispense bag whose flow into the internal fluid passage may be commenced after a protective cover 22, as in a peeling adhesive foil, is removed from the container's nozzle 16, prior to the nozzle shaft 18 being affixed to the receiver 14 by such conventional fittings as the Luer Lock 17 or screw threads 21.

These fittings are located on the nozzle shaft 18 and fit to mating fittings 23 in the receiver 14. The fluid container to be affixed to the top of the utensil handle body may be a bottle-type container or may be a syringe-type assembly with a syringe body 19 and a plunger 20 as shown in FIGS. 3c and 3d.

Fitting of fluid containers as depicted in FIG. 3 may also be employed to fitting the container inside the utensil handle body as in the embodiments shown in FIG. 2.

In the case of disposable embodiments of the claimed invention, the fluid containers may be directly fixed and be pre-filled with the fluid to be dispensed and the sealing cover 22 could be affixed over the exit holes found on the working end of the utensil until the utensils are to be used.

I claim:

1. A fluid utensil comprising:
an internal fluid passage, said passage having at least one exit hole at the working end of said utensil and an inlet hole at a fluid receiver, said receiver located proximal to said working end;
a fluid containing device, said device fitted into a utensil handle body proximal to said working end, a portion of said handle body and said working end containing within it said fluid passage; and
a fluid dispenser, said dispenser co-located with said containing device, said containing device actuated to dispense a liquid through said internal fluid passage toward said exit hole at said working end by said dispenser.

2. The utensil as in claim 1 wherein:
a portion of said handle body is constructed as a hollow cage, said cage having at least three cage legs, said legs extending down from the top of said handle body to the solid portion of said handle body, said solid portion having a receiver facing into said cage, said receiver meeting said internal fluid passage at the bottom of said receiver, said receiver formed to allow acceptance of the dispensing end of said fluid containing device to allow flow of liquid from said container into said internal fluid passage toward said exit holes after flow is actuated.

3. The utensil as in claim 1 wherein:
a portion of said handle body is constructed as a hollow enclosure, said enclosure having an orifice at the top of said enclosure, said enclosure having at its bottom said receiver, said receiver being formed into said solid portion of said handle body, said solid portion having a receiver facing into said enclosure, said receiver meeting said internal fluid passage at the bottom of said receiver, said receiver formed to allow acceptance of the dispensing end of said fluid containing device to allow flow of liquid from said container into said internal fluid passage toward said exit holes after flow is actuated.

4. The utensil as in claim 1 wherein:
said handle body has at the surface of its top end said receiver, said receiver being formed into said solid portion of said handle body and meeting said internal fluid passage at the bottom of said receiver, said receiver formed to allow acceptance of the dispensing end of said fluid containing device to allow flow of liquid from said container into said internal fluid passage toward said exit holes after flow is actuated.

5. The utensil as in claim 1 wherein:
said fluid containing device is a syringe assembly.

6. The utensil as in claim 1 wherein:
said fluid containing device is a bag.

7. The utensil as in claim 1 wherein:
said fluid containing device is a bottle.

8. The utensil as in any one of claims 1-7 wherein:
said working end is a spoon, said spoon having one of said exit hole, said hole entering the bowl of said spoon through said handle body.

9. The utensil as in any one of claims 1-7 wherein:
said working end is a fork having at least two prongs, said fork having one of said exit hole, said hole located on the top surface of said fork between the start of said prongs and the juncture of said fork with said handle body.

10. The utensil as in any one of claims 1-7 wherein:
said working end is a fork having at least two prongs, said fork having at least one of said exit holes, said holes located on the outer surface of the tip of at least one of said prongs, said prongs having within them branching fluid passages, said branching fluid passages extending through said prongs to an internal junction inside said juncture.

11. The utensil as in any one of claims 1-7 wherein:
said working end is the eating-end of a chopstick, said eating-end having one of said exit hole, said hole located on the outer surface of the tip of said eating-end.
